(19) United States
(12) Patent Application Publication
(10) Pub. No.: US 2011/0053100 A1
(43) Pub. Date: Mar. 3, 2011

(54) Composition and Method for Reducing Mercury Emitted into the Atmosphere

(76) Inventor: Rabindra K. SINHA, McKees Rocks, PA (US)

(21) Appl. No.: 12/900,885

(22) Filed: Oct. 8, 2010

Related U.S. Application Data
(63) Continuation-in-part of application No. 12/821,803, filed on Jun. 23, 2010.
(60) Provisional application No. 61/275,325, filed on Aug. 28, 2009.

(51) Int. Cl. B01D 53/02; B01D 53/64; F23C 99/00; C01B 31/08

(52) U.S. Cl. 431/2; 95/134; 502/416

(57) ABSTRACT

The present invention relates to sorbent compositions and methods to reduce the amount of mercury emitted into the atmosphere as a result of processing a mercury-containing material. The sorbent compositions include a sorbent source and at least one halogen material. The sorbent source is interacted with the halogen material to form a halogenated sorbent. The halogenated sorbent is contacted with a mercury-containing product (e.g., gas, vapor or mixtures thereof) which is produced as a result of processing a mercury-containing material. At least a portion of the mercury in the mercury-containing product is absorbed by the halogenated sorbent such that the level of mercury in said mercury-containing product is reduced.

### CROSS-REFERENCE TO RELATED APPLICATION

The present patent application is a continuation-in-part of U.S. patent application Ser. No. 12/821,803, filed Jun. 23, 2010, and entitled “Composition and Method for Reducing Mercury Emitted into the Atmosphere”, which is a traditional application of U.S. Provisional Patent Application Ser. No. 61/275,325, filed Aug. 28, 2009, and entitled, “Sorbent Compositions and Methods to Control Emissions of Mercury from Combustion Gases,” which are herein incorporated by reference in their entirety.

### FIELD OF THE INVENTION

The present invention relates to compositions and methods for reducing the amount of mercury released into the atmosphere as a result of processing mercury-containing materials. The present invention is useful, in particular, to reduce the level of mercury in flue gas that is emitted into the atmosphere as a result of oxidizing or burning mercury-containing fuel in a coal-fired combustion process.

### BACKGROUND OF THE INVENTION

There are significant coal resources in the world which are capable of satisfying at least a portion of the world's energy needs. For example, both high sulfur coal and low sulfur coal resources exist in various regions of the United States. However, there are processing issues related to the conversion of these resources into energy. Coal may require remediation steps to prevent pollutants, such as, for example, fly ash (e.g., particulates), sulfur, and mercury from being released into the atmosphere upon its combustion. Furthermore, anthropogenic fuels such as municipal wastes, industrial and medical wastes can also contain objectionable levels of mercury. It is known in the art that mercury is a potential environmental hazard and neurotoxin that may cause health problems for both humans and animals.

During the combustion process of coal, mercury is at least partially volatilized. As a result, the mercury is not contained within the coal ash that remains in the coal combustion facility, but instead, the mercury becomes a component of the flue gas which is released from the coal combustion facility into the atmosphere. Thus, remediation of the mercury-containing flue gases is needed to reduce or preclude the negative impact on the environment.

Currently, some coal combustion facilities capture mercury using equipment such as scrubbers and other control systems which are designed and implemented to partially remove mercury from flue gases generated during coal combustion prior to the flue gases being released into the atmosphere. The use of wet scrubbers to remove SOx (e.g., sulfur dioxide) and particulates can be somewhat effective for controlling the release of mercury. Other methods have included the use of activated carbon, modified activated carbon and various sorbent-based systems. Implementation of these systems can include significant capital and operational costs. Moreover, the use of activated carbon sorbents can lead to carbon contamination of the fly ash. In some facilities, the fly ash is collected in a particulate control device and the collected fly ash is used in other processes or products, such as, for example, in preparing cement. Thus, contamination of the fly ash can result in the loss of a source of revenue.

In various facilities, such as, coal burning facilities for electric utilities, there can be a significant amount of mercury contained in flue gases that is not captured and is therefore released into the atmosphere. In various facilities, such as, coal burning facilities for electric utilities. To address this issue of mercury released into the atmosphere in the United States, the Clean Air Act Amendments of 1990 contemplated the regulation and control of mercury. The Environmental Protection Agency (“EPA”) has published proposed clean air mercury limits in an attempt to regulate mercury emissions in the United States. The development of new rules on mercury emission limits and other hazardous emissions from the coal combustion process is of continued interest. Thus, there is a potential for new and more strict mercury control requirements in the future.

There is a need to design, develop and implement improved systems and processes to reduce the level of mercury emissions into the atmosphere from the processing of mercury-containing materials, such as, for example, reducing the level of mercury emissions into the atmosphere from gases generated as a result of oxidizing or burning mercury-containing fuel in a coal combustion process, other heat generating-recovery units or combinations thereof. Further, it is desirable for the systems and processes to be cost effective to build and operate.

### SUMMARY OF THE INVENTION

In one aspect, the present invention provides a sorbent composition to at least partially reduce the amount of mercury in a mercury-containing product selected from the group consisting of gas, vapor and mixtures thereof, the mercury-containing product produced as a result of processing a mercury-containing material. The sorbent composition includes a sorbent source and at least one halogen material. The interaction of the sorbent source and the at least one halogen material forms the sorbent composition, and the sorbent source includes carbon and the carbon is not activated carbon.

In another aspect, the present invention provides a method for preparing a sorbent source effective to reduce the level of mercury in a mercury-containing product selected from the group consisting of gas, vapor and mixtures thereof, the mercury-containing product produced as a result of processing a mercury-containing material. The method includes interacting a sorbent source with at least one halogen material to produce a halogenated sorbent. The sorbent source includes carbon. The carbon does not include activated carbon.

In still another aspect, the present invention provides a method for reducing the level of mercury emitted into the atmosphere as a result of processing a mercury-containing material. The method includes interacting a sorbent source with at least one halogen material to produce a halogenated sorbent. The sorbent source is selected from the group consisting of anthracite, metallurgical coke, petroleum coke, calcined coke, graphite, high temperature, calcined, or heat-treated bituminous coal, sub-bituminous coal, lignite and combinations thereof. The method further includes processing said mercury-containing material to produce a mercury-containing product selected from the group consisting of gas, vapor and mixtures thereof, and contacting the halogenated sorbent with the mercury-containing product to remove at least a portion of mercury from the mercury-containing product prior to the mercury-containing product being released into the atmosphere.

### BRIEF DESCRIPTION OF THE DRAWINGS

The invention as set forth in the claims will become more apparent from the following detailed description of certain preferred practices thereof illustrated, by way of example only, and the accompanying drawings, wherein

FIG. 1 is a schematic of an exemplary coal combustion process wherein a halogenated sorbent is introduced into the process in accordance with an embodiment of the invention;

FIG. 2 is a schematic of another exemplary coal combustion process wherein a halogenated sorbent is introduced into the process in accordance with an embodiment of the invention;

FIG. 3 is a schematic of still another exemplary coal combustion process wherein a halogenated sorbent is introduced into the process in accordance with an embodiment of the invention;

FIG. 4 is a schematic of the exemplary coal combustion process of FIG. 3 wherein a halogenated sorbent is introduced into the process in accordance with another embodiment of the invention;

FIG. 5 is a schematic of the exemplary coal combustion process of FIG. 1 wherein a halogenated sorbent is introduced into the process in accordance with another embodiment of the invention; and

FIG. 6 is a schematic of the exemplary coal combustion process of FIG. 2 wherein a halogenated sorbent is introduced into the process in accordance with another embodiment of the invention.

### DETAILED DESCRIPTION OF THE INVENTION

The present invention relates generally to compositions and methods for reducing the amount of mercury emitted into the atmosphere from the processing of mercury-containing materials. Mercury can be emitted into the atmosphere from mercury-containing materials when the mercury-containing materials are submitted to various processes and systems and produce a mercury-containing product therefrom. The mercury-containing materials can include a wide variety of mercury-containing solids, liquids and mixtures thereof. Mercury-containing products can include gases, vapors and mixtures thereof, produced as a result of processing the mercury-containing materials. Thus, the present invention can be employed in a wide variety of processes and systems that utilize mercury-containing materials and as a result, release mercury into the atmosphere. For example, the compositions of the present invention can be used to remove and reduce mercury from a variety of vapor and gaseous mercury-containing streams. In accordance with a particular embodiment, the present invention can be used in coal combustion facilities, such as coal burning facilities used by electric utilities to oxidize or burn mercury-containing fuels to produce heat and as a result, release mercury-containing flue gases into the atmosphere. For ease of description, the following description will illustrate this particular embodiment of the present invention.

In an aspect of the present invention, sorbent compositions are provided to process mercury-containing materials and products and ultimately, to reduce mercury emissions therefrom. The sorbent compositions contain components that can interact with mercury-containing products. For example, the sorbent compositions are contacted with a mercury-containing product and as a result, the mercury is partitioned from a gas phase or vapor phase to a sorbent phase. In a preferred embodiment, the sorbent compositions retain the forms of mercury present therein such that reduced levels of mercury are in the gas phase or vapor phase which is discharged into the atmosphere. In a coal combustion process, for example, a sorbent composition is contacted with either one of the coal and the mercury-containing flue gas, or both. As a result, the mercury level in the flue gas discharged into the atmosphere is reduced. The mercury-containing sorbent can be a portion of the fly ash. The fly ash can be collected in a particulate control device, such as, for example, an electrostatic precipitator (“ESP”), bag house, or the like.

The composition of the present invention includes a halogenated sorbent. The halogenated sorbent can be prepared by exposing a sorbent source to a halogen material including halogen, salt thereof (i.e., halide), or mixtures thereof. The amounts of each of the sorbent source and the halogen material used to prepare the halogenated sorbent can vary. In an embodiment, the amounts of each are such that the weight of the sorbent source after exposure to the halogen material is increased from about 0.5% to about 25% by weight. Suitable sorbent sources and halogen materials include those that interact with each other. In one embodiment, the sorbent source is a selected carbon-containing source. In a further embodiment, the selected carbon-containing source burns significantly slower than the fuel, e.g., coal material or coal-containing material, that is utilized in conventional coal combustion processes, e.g., the burn rate of the selected carbon-containing source is lower than the burn rate of the fuel or coal material used in the combustion process. Thus, the carbon-containing source used to produce a halogenated sorbent to remove mercury from fuel, is different from the fuel which is burned or oxidized in the combustion process. Suitable selected carbon-containing sources can include those that exhibit low volatility. For example, in an embodiment, the selected carbon-containing source can contain 12% or less, or from 3% to 12% or from 6% to 10%, of volatile matter. Suitable low volatility materials for use as a selected carbon-containing source in the present invention include, but are not limited to, coal material that is calcined or heat treated at high temperatures in an oxygen-limited atmosphere (e.g., inert). The temperature at which the coal material is calcined or heat treated can vary. In one embodiment, coal material can be calcined or heat treated at a temperature of about 1000° F. and higher, or about 900° F. and higher. Suitable coal material for use in the present invention can include anthracite (e.g., Pennsylvania anthracite); metallurgical coke; petroleum coke; calcined coke; graphite; high temperature, calcined, or heat-treated bituminous coal; sub-bituminous coal; lignite and combinations thereof.

In accordance with an embodiment of the present invention, the selected carbon-containing source does not include activated carbon, i.e., active carbon, active/activated charcoal, or active/activated coal. Activated carbon is a form of carbon that has been processed to make it highly porous and to have a high surface area. It is contemplated that there may be situations wherein the selected carbon-containing source and/or the halogenated sorbent composition of the present invention can be comingled with activated carbon; however, the activated carbon is not incorporated into the matrix of the selected carbon-containing source for interaction with the halogen material and/or is not incorporated into the matrix of the halogenated sorbent composition.

In alternate embodiments, the coal material for use in producing the halogenated sorbent composition of the present invention can be calcined or heat treated and then exposed to a halogen material or the coal material can be exposed to a halogen material and then calcined or heat treated.

The sorbent source can be used in various forms, such as, but not limited to, granular or powder. If a granular form of the sorbent source is used, it can be ground to various sizes.

The sorbent source is exposed to at least one halogen material. Suitable halogen material for use in the present invention includes, but is not limited to, conventional halogens known in the art, their salts, and mixtures thereof. In one embodiment, the at least one halogen material to be interacted with the sorbent source can include chlorine, iodine, bromine, salts thereof, and mixtures thereof. The halogen material can be used in its elemental form or can be converted into its elemental form from its salt. For example, in alternate embodiments, the halogen material can be elemental chlorine in the form of a gas, bromine in the form of a vapor or liquid, and iodine in the form of a solid. The salt form of the halogen material can be in various forms, such as, a solid, powder or aqueous solution. The elemental halogen gas can be contacted with the selected carbon-containing source in a fixed or fluidized bed. The gaseous halogen can be used in its pure form or diluted with a different gas, such as, but not limited to, nitrogen, helium, argon, or mixtures thereof, that does not interact with the selected carbon-containing source at the selected temperature for exposure of the halogen to the carbon-containing source to produce the halogenated sorbent of the present invention.

The liquid and solid forms of the halogen material, such as, but not limited to bromine and iodine, can be heated to a transition temperature at which the liquid or solid is transformed to a vapor. The vapor can then interact with the selected carbon-containing source to produce the halogenated sorbent of the present invention. In alternate embodiments, the vapor can be in its pure form or diluted with a different gas therefrom that does not interact with the carbon source, such as, but not limited to, nitrogen, helium, argon, or mixtures thereof, as described above.

In another embodiment, the halogen material for use in the invention can be prepared by interacting its corresponding halide with an oxidizing agent. The resulting halogen then can be contacted with the sorbent source. Suitable oxidizing agents can include a wide variety of materials known in the art. Non-limiting examples include alkali and alkaline metal perchlorites, perchlorates, permanganates, peroxides, and mixtures thereof. For example, in an embodiment, hydrochloric acid can be interacted with sodium hypochlorite to produce chlorine. In another embodiment, a halide can be used to prepare the halogenated sorbent composition of the present invention by combining the selected carbon-containing source with the halide, exposing the combination to an oxidizing agent, and heating to facilitate the interaction at a temperature that is lower than the temperature at which the oxidizing agent interacts with the selected carbon-containing source.

In one embodiment, the halide includes bromides of alkali and alkaline earth metals. In this embodiment, the selected carbon-containing source and the selected bromide are employed in amounts such that the halogenated sorbent produced therefrom contains from about 2 to about 15% by weight of bromide as bromine.

In the present invention, the sorbent source and the at least one halogen material are exposed to each other to produce a halogenated sorbent composition. The conditions under which the exposure is conducted can vary. The temperature at which the exposure is carried out can vary and is not limiting. Further, the duration of the exposure can vary and is also not limiting. The temperature and duration can depend on the rate of interaction of the selected sorbent source and the selected halogen material. The temperature should be such as to allow the sorbent source and the halogen material to sufficiently interact to produce a halogenated sorbent. For example, the sorbent source and halogen material can be heated to a wide variety of temperatures. In alternate embodiments, the temperature for heating is about 2000° F. and higher, or about 3000° F. and lower, or from about 50° F. to about 3000° F., or from about 70° F. to about 2500° F. The heating process can be conducted in an environment that includes a gaseous mixture. The gaseous mixture can include a variety of gases, such as, but not limited to nitrogen, carbon dioxide, oxygen, NOx (e.g., nitrogen dioxide, NO₂), SOx (e.g., sulfur dioxide SO₂), carbon monoxide, mercury and mixtures thereof. The gaseous mixture can further include water vapor. In one embodiment, the gaseous mixture includes from about 60% to about 80% by volume of nitrogen, from about 8% to about 12% by volume of carbon dioxide, from about 7% to about 12% by volume of water vapor, from about 1% to about 10% by volume of oxygen, less than about 2% by volume of NOx and/or SOx, less than about 0.1% by volume of CO and less than about 100 parts per billion by volume of mercury.

The sorbent source and halogen material can be exposed under heated conditions in the gaseous environment for a time period which can vary. The time period can be dependent on at least one of the following: the selected sorbent source, the selected halogen material, the amounts of each of the sorbent source and halogen material employed, and the rate of interaction of the sorbent source and halogen material. In one embodiment, the sorbent source and halogen material are exposed to the heated, gaseous environment for a duration of about five minutes or less. In alternate embodiments, the duration may be greater than five minutes. The resulting halogenated sorbent composition is operable to remove mercury from gas streams generated from, for example, the burning of mercury-containing fuels.

In another embodiment, the sorbent source and halogen material are heated employing a temperature of from about 500° F. and lower, or about 300° F. and lower, or about 200° F. and lower, or in the range of from about room temperature to about 300° F. In this embodiment, the halogen material used to form the halogenated sorbent can be selected from any of the halogen materials described herein. In a preferred embodiment, the halogen material is bromine gas or a mixture including bromine gas with chlorine gas and/or iodine gas. Further, in this embodiment, preferred sorbent sources include anthracite, petroleum coke, heat treated lignite, sub-bituminous and bituminous coals, and mixtures thereof. The heat treated lignite, sub-bituminous and bituminous coals can be produced by heating lignite, sub-bituminous and bituminous coals at a temperature of about 900° F. and higher in an inert environment for about less than four hours.

In one embodiment, the selected carbon-containing source is exposed to halogen selected from bromine, bromide (alkali and/or alkaline) and mixtures thereof, and oxidizing agents such as permanganates, perchlorates, perbromates, perthionates, alkali and alkaline hypochlorites and chorine gas; at a temperature below 300° F. for a period of time such that the halogenated sorbent composition produced therefrom contains about 2 to about 15% by weight of bromide and/or bromine. In a further embodiment, the halogenated sorbent composition produced can be introduced to a mercury-containing gas, such as, but not limited to, flue gas in gas ducts which are upstream of a particulate control device in a coal combustion process, at a temperature below about 800° F. or below about 400° F., at a rate equivalent to about 0.5 lb to about 8 lb per million actual cubic foot of the flue gas.

The sorbent source can also be exposed to a mixture of halides. In a preferred embodiment, the mixture of halides includes bromide and chlorine gas or chloride and an oxidizing agent such that bromine and chorine are subsequently liberated from its respective halide. In a further embodiment, the halogenated sorbent in this embodiment, is introduced into a mercury-containing flue gas at a temperature below about 400° F. in a coal combustion facility.

In one embodiment, the selected carbon-containing source is exposed to a halide selected from bromides of alkali and alkaline earth metals in amounts such that the final halogenated sorbent composition contains 2 to 10% by weight of bromide as bromine; in a gas-containing environment wherein the gas contains from about 50 to about 70% by volume of nitrogen, from about 5 to about 15% by volume of carbon dioxide, from about 5 to about 15% by volume of moisture, from about 1 to about 10% by volume of oxygen, less than about 2% by volume of combined SOx, NOx and carbon monoxide, and less than about 50 micro gram per cubic meter of mercury; at a temperature of from about 2000° F. to about 3000° F. for a time period of less than about ten minutes. In a further embodiment, the halogenated sorbent composition produced can be introduced to a fuel, such as, but not limited to, coal, in an amount of from about 0.1 lb to about 5 lb for every ton of fuel being burned in a combustion process.

Upon contact of the halogenated sorbent of the present invention with a mercury-containing gas, such as, flue gas in a coal combustion process, the mercury is at least partially removed from the flue gas and is absorbed or imbibed within the matrix of the halogenated sorbent. The halogenated sorbent, having mercury contained therein, then can be collected, for example, into a particulate control device (e.g., with the fly ash) of the coal combustion process.

The halogenated sorbent composition of the present invention can be contacted with a mercury-containing gas or vapor that is produced by processing a mercury-containing material. For example, in the embodiment of a mercury-containing fuel in a coal combustion process, the halogenated sorbent composition of the present invention can be contacted with the mercury-containing fuel when it is in various forms (e.g., particulate or gas) and when it is in various steps or phases of the combustion process. For example, the halogenated sorbent composition can be injected as a powder into the flue gas produced from the mercury-containing fuel, or the halogenated sorbent composition can be comingled into the fuel as the fuel is prepared (e.g., in fuel preparation equipment, such as, but not limited to, a coal mill) or as the fuel burns in a combustion furnace. When the halogenated sorbent composition is comingled into the fuel, the halogenated sorbent composition gets mixed well in the fuel preparation equipment or in the furnace. When the halogenated sorbent composition is injected into the flue gas, the halogenated sorbent composition can be in a powder form and can be injected into gas ducts through a system of lances and special nozzles such that the powder is adequately dispersed and comingled within the flue gas prior to entering a particulate control device.

As previously described, the present invention contemplates various embodiments wherein the selected carbon-containing source and/or the halogenated sorbent composition can be co-mingled with activated carbon and/or other such high carbon-content materials. Further, as previously described, the halogenated sorbent composition of the present invention can absorb at least a portion of the mercury from a mercury-containing material or product when said halogenated sorbent composition is contacted with said mercury-containing material or product. For example, in a coal combustion process, the resulting mercury-containing sorbent can be a portion of the fly ash collected in a particulate control device, such as, an ESP. The ESP can be used to control the emissions of particulates, such as, fly ash, into the atmosphere. It is further contemplated that the co-mingled halogenated sorbent and activated carbon and/or other such high carbon-content materials can cause the ESP performance to degrade. Such degradation may result in unacceptable emissions of particulates and fly ash into the atmosphere. Conditioners, such as, SO₃, NH₃ and mixtures thereof, which are known in the art to be effective to condition gas streams, such as, flue gas in a coal composition process, may not be effective when activated carbon and/or other such high carbon-content materials are present. In accordance with the present invention, it has been found that conditioning compositions including ammonium nitrate, lithium nitrate or mixtures thereof, are effective to condition mercury-containing materials or products, such as, flue gas, in the presence of activated carbon and/or other such high carbon-content materials. Optionally, the conditioning composition of the present invention can further include water. It has been demonstrated, wherein the selected carbon-containing source and/or halogenated sorbent composition is co-mingled with activated carbon and/or other such high carbon-content materials, that the performance of an ESP remains acceptable when the flue gas conditioning is conducted by adding, for example, by injecting, an aqueous solution of ammonium nitrate, lithium nitrate or mixtures thereof into the flue gas prior to, coincident with or following entry of the flue gas into the ESP.

In one embodiment, the mercury-containing material, e.g., fuel, is processed, e.g., oxidized or burned, such that a gas stream is produced, e.g., flue gas. The sorbent composition of the present invention is effective to remove at least a portion of the mercury in the mercury-containing flue gas. Thus, when in contact with the mercury-containing flue gas, the flue gas that is ultimately emitted from the process and released into the atmosphere has a reduced level of mercury contained therein as compared to the level of mercury initially contained within the flue gas produced from oxidizing or burning the mercury-containing fuel. The mercury removed from the gas is absorbed into the sorbent composition. The mercury-containing sorbent composition can be collected with the particulate and fly ash, for example, in the coal combustion process.

In one embodiment, for example, the halogenated sorbent is contacted with flue gas produced as a result of oxidizing mercury-containing fuel, such as, coal. The halogenated sorbent is effective to absorb at least a portion of the mercury contained in the flue gas such that the flue gas has a reduced amount of mercury contained therein after contact with the halogenated sorbent, as compared to the amount of mercury in the flue gas prior to contact with the halogenated sorbent. The flue gas, having a reduced mercury content, is then released into the atmosphere.

As a result of contact with the mercury-containing flue gas, the halogenated sorbent has an increased amount of mercury contained therein as compared to the amount of mercury contained in the halogenated sorbent prior to its contact with the flue gas. The mercury-containing halogenated sorbent can be mixed or combined with the ash or fly ash produced in the coal combustion process and collected in a container such as a hopper in a particulate control device.

The halogenated sorbent can be introduced directly into a mercury-containing gas such that the halogenated sorbent is in contact with the gas to reduce the level of mercury therein. In alternate embodiments, the halogenated sorbent can be introduced to the mercury-containing material prior to it being processed to produce a mercury-containing gas therefrom. Thus, in one embodiment, wherein a mercury-containing fuel, such as, coal, is oxidized or burned in a coal combustion process, the halogenated sorbent can be introduced at various steps and phases within the combustion process. In one embodiment, the halogenated sorbent can be introduced to the mercury-containing fuel when the fuel is prepared. For example, the halogenated sorbent can be introduced to the fuel preparation equipment, including, but not limited to, a coal mill, prior to the fuel being oxidized or burned in a furnace. In another embodiment, the halogenated sorbent and the mercury-containing fuel can both be introduced into the furnace. In alternate embodiments, the halogenated sorbent can be introduced to the flue gas generated in the furnace or following its discharge from the furnace. In a further embodiment, the halogenated sorbent is introduced to the flue gas following its discharge from the furnace and prior to it entering a particulate control device.

In a further embodiment, the halogenated sorbent in the form of granules is introduced into the fuel preparation equipment, e.g., a coal mill. In this embodiment, the granular sorbent source is ground to a particle size such that it can pass through a 10 mesh (US sieve size) screen or screens having larger mesh size.

In another embodiment, the granular halogenated sorbent can be introduced into a flue gas stream downstream of a pre-heater. The pre-heater is typically employed in the boiler for pre-heating the combustion air. In this embodiment, the sorbent source is ground to a particle size such that it can pass through a 200 mesh (US sieve size) screen or screens having a smaller mesh size.

In still another embodiment, the halogenated sorbent composition of the present invention can be formed by individually introducing the selected carbon-containing source and the halogen material into a combustion process. In one embodiment, wherein the mercury-containing material is fuel and the mercury-containing product is flue gas produced from the combustion of the mercury-containing fuel, the halogenated sorbent composition can be formed in various steps or phases throughout the combustion process. For example, the selected carbon-containing source can be introduced with the fuel prior to being introduced into the furnace or the selected carbon-containing source can be introduced into the furnace. The halogen material can be introduced at various steps in the combustion process downstream of the furnace but prior to a particulate control device. For example, the halogen material can be introduced into the flue gas exiting the furnace such that the halogen material interacts with the selected carbon-containing source contained in the flue gas.

Alternatives for introducing the halogenated sorbent composition of the present invention into a coal combustion process are further described.

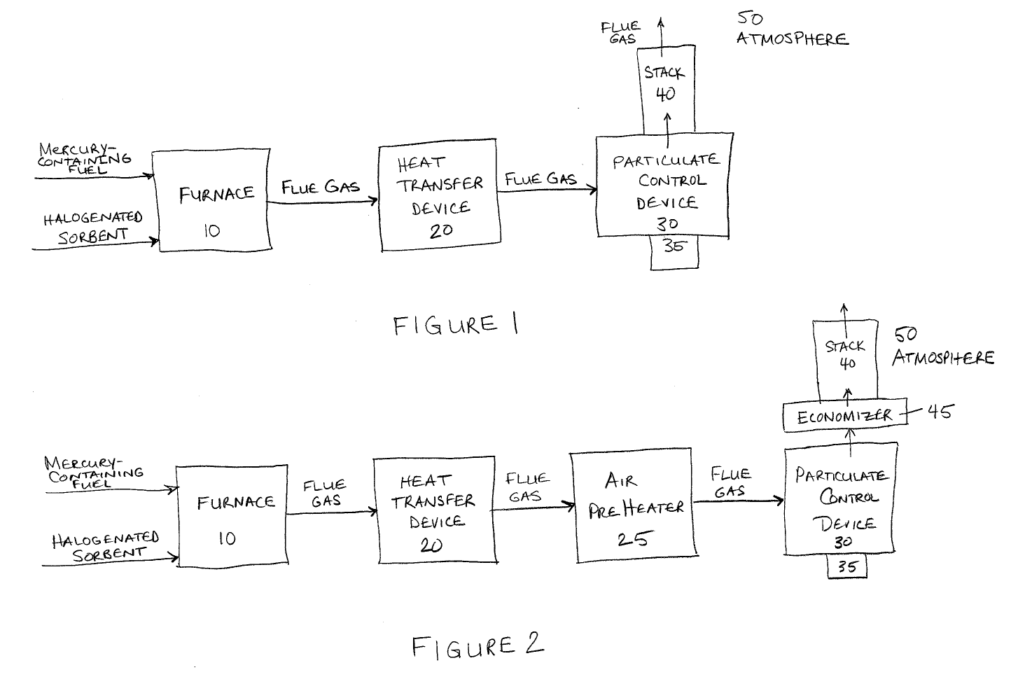

FIG. 1 is a schematic diagram which shows an exemplary coal combustion process. The halogenated sorbent is introduced with the mercury-containing fuel into a furnace 10 and burned in the presence of air or oxygen in the combustion portion (not shown) of the furnace 10. The temperature in the combustion portion of the furnace 10 typically ranges from about 2700° F. to about 3000° F. The flue gas generated in the furnace 10 exits therefrom and is fed into a heat transfer device 20 to recover heat from the flue gas. The heat transfer device 20 can include, but is not limited to, boiler tubes, super heater and re-heater tubes, convective pass, economizers, pre-heaters and combinations thereof. The flue gas then exits the heat transfer device 20 and is fed into a particulate control device 30. In the particulate control device 30, the ash entrained in the flue or fly ash is removed and is collected in one or more hopper 35 positioned underneath the particulate control device 30. The halogenated sorbent containing mercury can be combined with the ash or fly ash and removed from the particulate control device 30 and collected in the hopper 35. The reduced mercury-containing flue gas is then discharged through at least one stack 40 and into the atmosphere 50.

The particulate control device 30 can include cold-side ESP, bag house(s) and combinations thereof. In an embodiment, wherein cold-side ESP is employed, the flue gas entering therein can be at a temperature about 550° F. or less.

FIG. 2 shows another embodiment of the present invention. FIG. 2 includes the furnace 10, heat transfer device 20, particulate control device 30, hopper 35, stack 40 and atmosphere 50 shown in FIG. 1. FIG. 2 further includes an economizer 22 and an air pre-heater 25. In accordance with this embodiment, the halogenated sorbent and mercury-containing fuel are introduced into the furnace 10 and burned in the presence of air or oxygen in the combustion portion (not shown) of the furnace 10. The temperature in the combustion portion of the furnace 10 typically ranges from about 2700° F. to about 3000° F. The flue gas generated in the furnace 10 exits therefrom and is fed into a heat transfer device 20 to recover heat from the flue gas. The heat transfer device 20 can include, but is not limited to, boiler tubes, super heater and re-heater tubes, convective pass, economizers, pre-heaters and combinations thereof. The flue gas then exits the heat transfer device 20 and is fed into the economizer 22. The flue gas exits the economizer 22 and is fed into the air pre-heater 25. The flue gas then exists the pre-heater 25 and is fed into the particulate control device 30. In the particulate control device 30, the ash entrained in the flue or fly ash is removed and is collected in one or more hopper 35 positioned underneath the particulate control device 30. The mercury-containing, halogenated sorbent can be combined or mixed with the ash or fly ash and removed from the particulate control device 30 and collected in the hopper 35. The reduced mercury-containing flue gas is then discharged through at least one stack 40 and into the atmosphere 50.

In an embodiment, the particulate control device 30 can include a hot side ESP which is positioned between the economizer 22 and the air pre-heater 25. In hot-side ESP, the gas temperatures can be between about 700° F. and about 800° F.

FIG. 3 shows another embodiment of the present invention. FIG. 3 includes the furnace 10, heat transfer device 20, particulate control device 30, hopper 35, stack 40 and atmosphere 50 shown in FIG. 1. FIG. 3 further includes fuel preparation equipment 5 and pre-heater 7 positioned upstream of the furnace 10. In accordance with this embodiment, the halogenated sorbent and mercury-containing fuel are introduced into the fuel preparation equipment 5. The fuel then exits the fuel preparation equipment 5 and is fed into the pre-heater 7. The fuel exits the pre-heater 7 and is fed into the furnace 10, and the fuel is burned in the presence of air or oxygen in the combustion portion (not shown) of the furnace 10. The temperature in the combustion portion of the furnace 10 typically ranges from about 2700° F. to about 3000° F. The flue gas generated in the furnace 10 exits therefrom and is fed into a heat transfer device 20 to recover heat from the flue gas. The heat transfer device 20 can include, but is not limited to, boiler tubes, super heater and re-heater tubes, convective pass, economizers, pre-heaters and combinations thereof. The flue gas then exits the heat transfer device 20 and is fed into the particulate control device 30. In the particulate control device 30, the ash entrained in the flue or fly ash is removed and is collected in one or more hopper 35 positioned underneath the particulate control device 30. The mercury-containing, halogenated sorbent can be combined or mixed with the ash or fly ash and removed from the particulate control device 30 and collected in the hopper 35. The reduced mercury-containing flue gas is then discharged through at least one stack 40 and into the atmosphere 50.

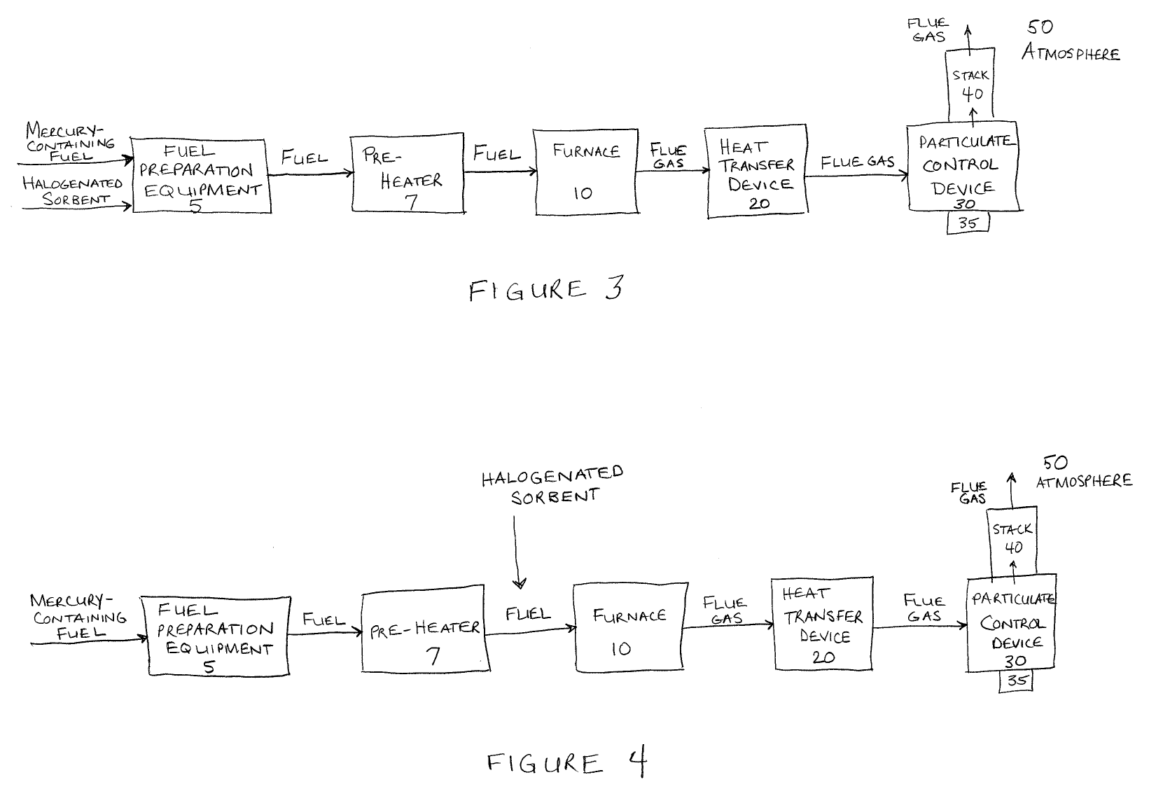

FIG. 4 shows another embodiment of the present invention. FIG. 4 includes the fuel preparation equipment 5, pre-heater 7, furnace 10, heat transfer device 20, particulate control device 30, hopper 35, stack 40 and atmosphere 50 shown in FIG. 3. In FIG. 4, the halogenated sorbent is introduced into the fuel following the fuel having been prepared in the fuel preparation equipment 5 and pre-heater in the pre-heater 7. The process for burning the fuel and reducing the mercury in the flue gas released into the atmosphere is the same as described previously in accordance with FIG. 3.

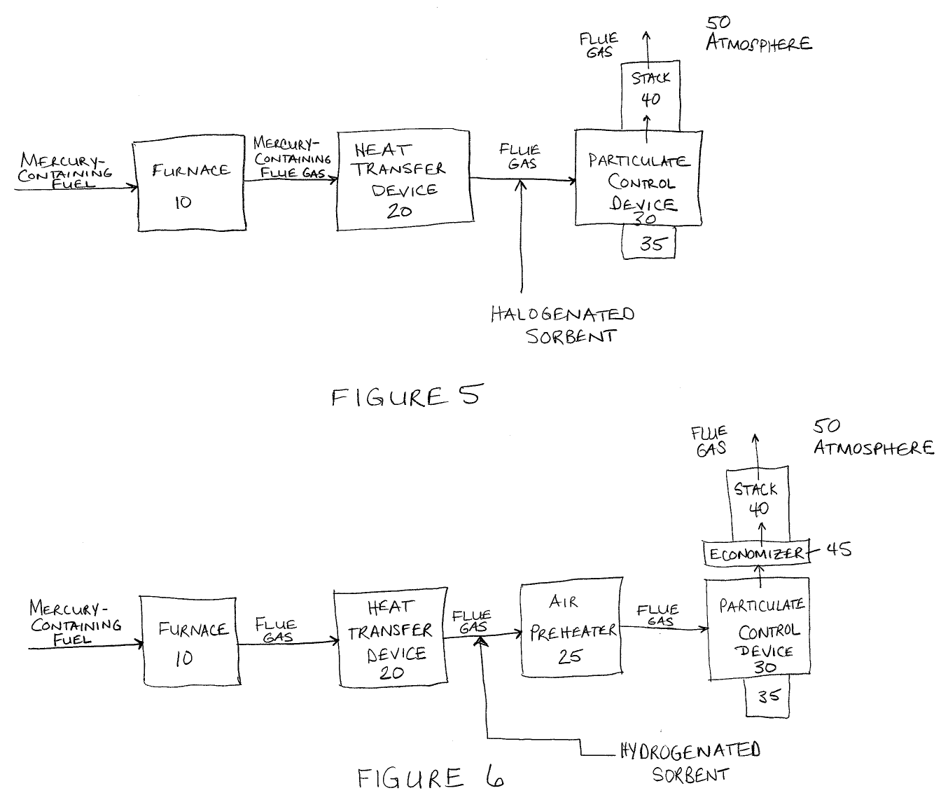

FIG. 5 shows another embodiment of the present invention. FIG. 5 includes the fuel furnace 10, heat transfer device 20, particulate control device 30, hopper 35, stack 40 and atmosphere 50 shown in FIG. 1. In FIG. 5, the halogenated sorbent is introduced into the flue gas that exits from the heat transfer device 20 prior to entering the particulate control device 30. The halogenated sorbent can be in the form of a powder and the powder is added to the combustion gases after most of the heat of combustion that can be recovered has been recovered in the heat transfer device 20 and prior to or upstream of the particulate control device 30 wherein the ash is separated from the flue gas.

FIG. 6 shows another embodiment of the present invention. FIG. 6 includes the furnace 10, heat transfer device 20, economizer 22, air pre-heater 25, particulate control device 30, hopper 35, stack 40 and atmosphere 50 as shown in FIG. 2. In FIG. 6, the halogenated sorbent is introduced into the flue gas that exists from the heat transfer device 20 prior to entering the air pre-heater 25. In alternate embodiments, the halogenated sorbent can be introduced into the flue gas as it exits the heat transfer device 20 and prior to it entering the economizer 22, or as the flue gas exits the economizer 22 and prior to it entering the air pre-heater 25, or in both locations. The halogenated sorbent can be in the form of a powder.

As shown in the exemplary illustrations of FIGS. 1 through 6, the halogenated sorbent composition of the present invention can be introduced into the mercury-containing fuel or the gas generated therefrom at various steps in the combustion process. It is desirable that the halogenated sorbent composition is introduced at a step, wherein it can be well-mixed with the mercury-containing fuel or the gas generated therefrom. For example, halogenated sorbent composition can be added to the furnace 10 or the post furnace system (e.g., downstream of the furnace 10 and upstream of the particulate control device 30). The halogenated sorbent composition is effective to remove or absorb at least a portion of the mercury present in the ash entrained flue gas. The halogenated sorbent and the mercury absorbed therein can become a part of the ash and may be removed together with fly ash as particulates by the particulate control device 30 and collected in the hopper 35. The gas having a reduced amount of mercury exits the particulate control device 30 through a stack 40 into the atmosphere 50.

In another embodiment, when the halogenated sorbent composition is introduced into the flue gas, it can be dispersed and co-mingled with the flue gas in the gas ducts, for example, in the gas ducts between the air pre-heater 25 and the particulate control device 30 prior to the flue gas entering the particulate control device 30, as shown in FIG. 6. In this embodiment, the halogenated sorbent can be in a powder form and introduced, for example, by injection, into a gas duct using lances and nozzles which are known in the art and commercially available, at a temperature of about 900° F. and lower, or about 800° F. and lower.

In coal-fired furnaces, the flue gases can include the presence of mercury in various forms. For example, the mercury can be elemental mercury, oxidized mercury and/or particulate mercury. The distribution of these forms of mercury can vary based on coal type, firing equipment and methods of firing. The halogenated sorbent composition of the present invention is effective to reduce the amount of mercury that is present in these various forms.

In some coal-burning facilities, mercury emissions are monitored. Thus, based on the level of mercury measured in the flue gas prior to emission from the facility, the amount of halogenated sorbent composition introduced into the flue gas may be increased, decreased or unchanged. In general, it is desirable to reduce the mercury level in a mercury-containing gas to as low as is possible. In an embodiment, the halogenated sorbent composition can remove at least 90% of the mercury in a mercury-containing gas based on the total amount of mercury in the mercury-containing material from which the gas is generated, e.g., coal, and the amount of the halogenated sorbent introduced therein.

Whereas particular embodiments of the invention have been described herein for purposes of illustration, it will be evident to those skilled in the art that numerous variations of the details may be made without departing from the invention as set forth in the appended claims.

### EXAMPLES

### Example 1

The examples provided below assist in exemplifying the method of preparation and the results of the halogenated sorbent of the present invention. Variations in the methods of preparing the sorbents and their effectiveness in removing mercury can be appreciated by those having ordinary skill in the art. These examples are for illustrative purposes only and are not meant to limit the scope of the present invention in any way.

The following sorbent sources were used in these examples:

Antharcite coal which was commercially available from Reading Anthracite, Pa.;

Petroleum coke in the forms of (i) fluid coke and (ii) delayed coke which were both commercially available from Defler Enterprises, Buffalo, N.Y.;

Calcined pet coke which was commercially available as Ti coke from Kingswood, Tex.;

Sub-bituminous coal which was commercially available from Powder River Basin (“PRB”), Wyoming;

Lignite which was commercially available from BNI Corporation, ND, Sugar char which was laboratory-made by heating commercially available sugar (sucrose);

De-volatilized sub-bituminous, PRB coal which was calcined in the absence of air at a temperature in the range of from about 1800° F. to about 2000° F.;

Hopper ash from PRB coal combustion which contained about 0.1% unburned carbon;

Hopper ash from bituminous coal combustion which contained about 5% unburned carbon;

Carbon black which was commercially available under the trade name Monarch 1300 from Cabot Carbon Corporation;

Secondary graphite which was commercially available from Graphon Corporation;

Bentonite which was commercially available from Wyoming; and

Exfoliated vermiculite which was commercially available as packing material, having a particle size such that it could be passed through 8 US mesh screen.

About 5 grams of each of the above sorbent sources was separately exposed to halogens selected from chlorine, bromine and iodine. The exposures were conducted at room temperature and in closed containers. The interaction of the halogen was generally rapid with the carbonaceous materials evaluated. For example, the anthracite, both types of petroleum cokes (i.e., fluid and delayed cokes), secondary graphite, carbon black and devolatilized PRB coal, each had a carbon content ranging from about 90% to about 99% on an ash-free basis, and each interacted with bromine vapors within several minutes at room temperature. These carbon sources were determined to contain (load up) from about 5% to about 15% by weight of bromine based on the final product. The interaction of bromine with some selected carbon sources, such as raw PRB coal, lignite, materials containing carbon in the range of from 0.1% to 5%, and materials that did not contain carbon, was not as effective for mercury removal.

### Example 2

An approximately 500 ml sample of each of the carbon sorbent sources listed in Table 1 below were treated with halogens selected from chlorine, bromine, chloride, bromide and mixtures of chloride and bromide. The chlorine and bromine sources were either in the form of pure chlorine gas and pure bromine gas or these compounds were liberated as a result of chemical reactions well known in the art, such as the reaction of chloride (e.g., HCL, NaCl, and CaCl₂) with acidified potassium permanganate or potassium chlorate and HCl with potassium permanganate to produce chlorine. Further, bromine gas was prepared by exposing a sorbent source impregnated with NaBr, KBr or CaBr₂ to chlorine gas by mixing HCl with potassium permanganate.

In Table 1, the “VM” designation represents the amount of “volatile matter” contained in the carbon sorbent sources. The volatile matter was measured in accordance with ASTM D-3175. Further, in Table 1, the ash, BTU/lb and sulfur measurements reported were measured in accordance with ASTM D-3174, ASTM D-5865 and ASTM D-4239, respectively.

TABLE 1
Selected Sorbent Properties and Preparation Mix

| | |
|---|---|
| 1. | Anthracite Coal: Sample I-(VM-5.6%; Ash-14.7%; |
| | BTU/lb-11,924; Sulfur-0.52%)-and Sample II (VM-5.05%; |
| | Ash-12.88%; BTU/lb-12,636; Sulfur-0.86%) |
| 2. | Petroleum Coke-Fluid Coke Type: (VM-5.72%; Ash-0.13%; |
| | Sulfur-7.34%; BTU/lb-14,211) and Delayed Coke |
| | Type-(VM-10.23%; Ash-0.22%; Sulfur-3.65%; BTU/lb-15,214) |
| 3. | Calcinated Petroleum Coke-available as Ti Coke (VM-0.61%; |
| | Ash-0.54%; Sulfur-4.81%; BTU/lb-13681) |
| 4. | Sub-bituminous Coal - Powder River Basin (PRB), Wyoming |
| | (VM-51.582%; Ash-7.23%; Sulfur-0.35%; BTU/lb-12,038) |
| 5. | PRB heat treated at high temperature of about 1800° F. |
| | for 30 minutes (VM-25.5%) |
| 6. | Lignite-(Moisture-37%; VM-38%; Ash-6.3%; Sulfur-0.55%; |
| | BTU/lb: 6145) |
| 7. | Lignite, heat treated at high temperature of about 1200° F. |
| | (VM-24%; Ash-8.9%; Sulfur-0.8%) |
| 8. | Sugar Char, made in laboratory by heating commercially |
| | available sugar (sucrose) at about 400° F. |
| 9. | Hopper Ash from Bituminous coal combustion, containing |
| | about 5% unburned Carbon |
| 10. | Carbon Black, Monarch 1300, available from Cabot Carbon |
| | Corporation |
| 11. | Secondary Graphite available from Graphon Corporation |
| 12. | Bentonite from Wyoming |
| 13. | Exfoliated Vermiculite (commercially available as packing |
| | material, passing through 100 USS mesh screen) |

Several of the sorbent sources identified in Table 1, in particular, the anthracite, calcined PRB and petroleum cokes were impregnated with sodium bromide to prepare the brominated sorbents which contained about 8% bromide in the final, dried product. The bromide impregnated samples were also heat treated in air at temperatures of 900° C., 1000° C. and 1200° C. so as to re-create the conditions of a furnace in a coal combustion system. The residuals remaining following exposure for periods of 5, 10 and 15 minutes, were tested for their effectiveness as sorbents for mercury removal with the sorbents prepared in accordance with Table 1. The sorbents, with the exception of the sorbent prepared with Bentonite, were tested either on an actual flue gas stream containing mercury (a side stream of a PRB coal burning power plant) or to a synthetic gas-containing doped mercury or by subjecting it to a surrogate test method correlated with field tests.

The interaction of bromine with fly ash and vermiculite (see items 6, 7 and 12 in Table 1) were slow but in both instances about 1-5% by weight of bromine was added to the ash in sealed containers. The bromine was slowly absorbed by the ash over a period of about several hours. The interaction of bromine with the Bentonite was very slow.

In addition to introducing elemental halogens to the source materials, halogens produced by oxidizing halides such as chloride, bromide and iodide with oxidizing agents, were also used.

The above-mentioned test showed that the samples prepared from highly carbonaceous materials, such as anthracite, pet coke, devolatilized PRB, devolatilized lignite, graphite and carbon black, exhibit very good mercury removal capability. For example, when tested on a side stream of a flue gas from a PRB coal burning power plant, the chlorine-treated and bromine-treated highly carbonaceous source materials were capable of removing from about 30% to about 95% of the inlet mercury. In these tests, the chlorinated products had lower (e.g., about 30% removal) capacities than the brominated products (e.g., 80-95% removal).

1. A sorbent composition to at least partially reduce the amount of mercury in a mercury-containing product selected from the group consisting of gas, vapor and mixtures thereof, the mercury-containing product produced as a result of processing a mercury-containing material, said composition comprising:
a sorbent source; and
at least one halogen material,
wherein an interaction of the sorbent source and the at least one halogen material forms the sorbent composition, and wherein the sorbent source comprises carbon and the carbon is not activated carbon.

2. The composition of claim 1 wherein the sorbent source comprises coal material that is calcined or heat treated in an oxygen-limited atmosphere.

3. The composition of claim 1 wherein the sorbent source is selected from the group consisting of anthracite, metallurgical coke, petroleum coke, calcined coke, graphite, high temperature, calcined or heat-treated lignite, bituminous coal, sub-bituminous coal and combinations thereof.

4. The composition of claim 2 wherein the coal material is calcined at a temperature of 1000° F. and higher.

5. The composition of claim 1 wherein the sorbent composition is in a form selected from the group consisting of powder, granular and mixtures thereof.

6. The composition of claim 1 wherein the halogen material is selected from the group consisting of chlorine, iodine, bromine, salts thereof, and mixtures thereof.

7. The composition of claim 1 wherein a material selected from the group consisting of activated carbon, other such high carbon-content materials and mixtures thereof, is co-mingled with a compound selected from the group consisting of the sorbent composition and the sorbent source.

8. The composition of claim 6 wherein the halogen material is in a form selected from the group consisting of its elemental form and its salt form which is converted into its elemental form by interacting the halogen material with an oxidizing agent.

9. A method for preparing a sorbent source effective to reduce the level of mercury in a mercury-containing product selected from the group consisting of gas, vapor and mixtures thereof, the mercury-containing product produced as a result of processing a mercury-containing material, said method comprising:
interacting a sorbent source with at least one halogen material to produce a halogenated sorbent, the sorbent source comprised of carbon, wherein the carbon is not activated carbon.

10. The method of claim 9 wherein the interacting step further comprises a gas environment wherein the gas is selected from the group consisting of nitrogen, carbon dioxide, oxygen, NOx, SOx, carbon monoxide, mercury, water vapor and mixtures thereof.

11. The method of claim 10 wherein the gas environment comprises from about 60% to about 80% by volume of nitrogen, from about 8% to about 12% by volume of carbon dioxide, from about 7% to about 12% by volume of water vapor, from about 1% to about 10% by volume of oxygen, less than about 2% by volume of NOx and/or SOx, less than about 0.1% by volume of carbon monoxide and less than about 100 parts per billion by volume of mercury.

12. The method of claim 9 wherein the interacting step is carried out at a temperature of from about 50° F. to about 3000° F.

13. A method for reducing the level of mercury emitted into the atmosphere as a result of processing a mercury-containing material, the method comprising:
interacting a sorbent source with at least one halogen material to produce a halogenated sorbent, the sorbent source selected from the group consisting of anthracite, metallurgical coke, petroleum coke, calcined coke, graphite, high temperature, calcined or heat-treated lignite, bituminous coal, sub-bituminous coal and combinations thereof;
processing said mercury-containing material to produce a mercury-containing product selected from the group consisting of gas, vapor and mixtures thereof; and
contacting the halogenated sorbent with the mercury-containing product to remove at least a portion of mercury from the mercury-containing product, prior to the mercury-containing product being released into the atmosphere.

14. The method of claim 13 wherein the at least of portion of mercury removed from said mercury-containing product is at least partially absorbed in the halogenated sorbent.

15. The method of claim 13 wherein the halogenated sorbent is contacted with the mercury-containing product which is used in a coal combustion process.

16. The method of claim 13 wherein the mercury-containing material is in the form of fuel and wherein the mercury-containing product is in the form of flue gas.

17. The method of claim 13 wherein the sorbent source and the at least one halogen material are individually introduced into the combustion process to form the halogenated sorbent.

18. The method of claim 15 wherein the halogenated sorbent is contacted with the mercury-containing product in a combustion furnace.

19. The method of claim 15 wherein the halogenated sorbent is introduced into fuel preparation equipment prior to introducing the mercury-containing material into a combustion furnace.

20. The method of claim 13 wherein the halogenated sorbent is contacted with the mercury-containing product after the mercury-containing product exits from a combustion furnace and prior to the mercury-containing product entering a particulate control device.

21. The method of claim 13 wherein at least one of the sorbent source and the halogenated sorbent is co-mingled with a material selected from the group consisting of activated carbon, other such high carbon-content materials and mixtures thereof.

22. The method of claim 21 wherein a conditioning composition is added to the mercury-containing product, said conditioning composition comprising a compound selected from the group consisting of ammonium nitrate, lithium nitrate, and mixtures thereof.
